(19) United States
(12) Patent Application Publication
(10) Pub. No.: US 2025/0307260 A1
(43) Pub. Date: Oct. 2, 2025

(54) METHODS FOR INTELLIGENTLY GENERATING A SEARCH QUERY TO ACCESS DATA AND DEVICES THEREOF

(71) Applicant: Jones Lang LaSalle IP, Inc., Chicago, IL (US)

(72) Inventors: Nathan HARRIS, London (GB); Oliver ARAGON-ARANDA, Madrid (ES); Kay TANG, London (GB); Qian HU, Madrid (ES); Hector MORENO CERVERA, Boadilla del Monte (ES)

(21) Appl. No.: 18/623,232

(22) Filed: Apr. 1, 2024

(51) Int. Cl. G06F 16/248

(52) U.S. Cl. CPC G06F 16/248

(57) ABSTRACT

This technology relates to intelligently generate a search query to access data. A method, computing device, and non-transitory computer readable medium include receiving a search request comprising natural language text. Then a prompt from the natural language text is extracted. A search generation machine learning model is executed to generate one or more search criteria based on the extracted prompt, wherein the search generation machine learning model is trained to learn data storage structure information of a data storage and map a prompt to one or more search criteria based on the learned data storage structure information. The data storage is searched based on the one or more search criteria to obtain a search result. The search result is displayed via a user interface as a response to the search request.

### FIELD

This technology relates to methods, computing devices, and non-transitory computer readable medium that intelligently generating a search query to access data.

### BACKGROUND

To access data stored in a digital data storage, people normally need to fill out a plurality of fields via a user interface to indicate some criteria to filter the stored data. For this purpose, a filter panel as illustrated in FIGS. 1A-1B may be incorporated into the user interface for a user to input data. In this example, to identify target properties from thousands of properties stored in a database, the user makes selections among the scrollable sections, featuring switches, sliders, and checkboxes to provide input data. The closer the input data match the fields of tables stored in the database, the more accurate result the user would receive.

Unfortunately, most of such filter panels or similar input mechanisms are specific to a platform or a product, often featuring terminology and relationships between terms which may not reflect the mental model of the user and/or the terms and layout most intuitive to them. Therefore, when a user changes from a platform or a product to another, the user may have to spend extra time to be familiar with the new filter panel and take multiple attempts to learn how a specific filter panel works. Then the user would have to laboriously fill out the filter panel every time even the user is looking for similar properties on the same platform. This search process could be time consuming and arduous for the user. Additionally, a user may have additional search criteria to add while the uniform filter panel provided on the user interface does not offer a entry for the user to input such additional search criteria. Therefore, a more intelligent solution is desired.

### SUMMARY

A method for intelligently generating a search query to access data includes receiving, by a computing device, a search request comprising natural language text. Extracting a prompt from the natural language text by the computing device. A search generation machine learning model is executed by the computing device, to generate one or more search criteria based on the extracted prompt. The search generation machine learning model is trained to learn data storage structure information of a data storage and map a prompt to one or more search criteria based on the learned data storage structure information. Search, by the computing device, the data storage based on the one or more search criteria to obtain a search result. Display, by the computing device, the search result via a user interface as a response to the search request.

A computing device with a memory comprising programmed instructions stored thereon and one or more processors configured to execute the stored programmed instructions to receive a search request comprising natural language text. A prompt is extracted from the natural language text. Execute a search generation machine learning model to generate one or more search criteria based on the extracted prompt, the search generation machine learning model is trained to learn data storage structure information of a data storage and map a prompt to one or more search criteria based on the learned data storage structure information. Search the data storage based on the one or more search criteria to obtain a search result. Display the search result via a user interface as a response to the search request.

A non-transitory computer readable medium having stored thereon instructions comprising executable code which when executed by one or more processors, causes the one or more processors to receive a search request comprising natural language text. Extract a prompt from the natural language text. Execute a search generation machine learning model to generate one or more search criteria based on the extracted prompt, the search generation machine learning model is trained to learn data storage structure information of a data storage and map a prompt to one or more search criteria based on the learned data storage structure information. Search the data storage based on the one or more search criteria to obtain a search result. Display the search result via a user interface as a response to the search request.

This technology provides a number of advantages including providing methods, non-transitory computer readable media, and computing devices that substantially enhance the intelligent generation of a search query to access data. Examples of this technology are able to free a user from filing out a specific panel with a plurality of predefined fields to perform a search of data stored in a data source. Instead, this technology allows a user to submit a search request in natural language and therefore the user may compose and include any search conditions or filters in the natural language search request. Examples of this technology may analyze a user's search request, select one or more criteria based on its analyzed user search request, and conduct a search without a user's further interference. By removing the limitations on the search conditions or filters that a user may use to compose the search request, this technology may utilize more filters to search the stored data and provide more accurate search result to a user. By use of machine learning based models, a user's search request may be analyzed in a more powerful way and a search may be more efficient by learning the data structure information of related data sources. The machine learning based model may be trained on an ongoing basis on latest data collected from a variety of data resources. Examples of this technology may further provide recommendations for the user to supplement or support the user to formulate a search request. As a result, this technology may provide an intelligent tool for a user to conduct a search and return a search result having a higher quality and more insights to the user. Therefore, examples of this technology disclose herein at least alleviate some of above issues.

### BRIEF DESCRIPTION OF THE DRAWINGS

The foregoing and other aspects of the present disclosure can be understood from the following detailed description when read in connection with the accompanying drawings. For the purpose of illustrating this technology, specific examples are shown in the drawings, it being understood, however, that the examples of this technology are not limited to the specific instrumentalities disclosed. Included in the drawings are the following Figures:

FIGS. 1A-1B are screenshots of an exemplary filter panel of a user interface provided to a user for performing a property search;

FIG. 2 is a block diagram of an exemplary network environment with a platform management computing device;

FIG. 3 is a block diagram of an exemplary execution environment of a platform management computing device;

FIG. 4 is a block diagram of an exemplary computing device residing on and being executed by a platform management computing device;

FIG. 5 is a flowchart of an exemplary method for intelligently generating a search query to access data;

FIG. 6 is a functional block diagram illustrating an exemplary training of a search generation machine learning model and interactions with a user;

FIG. 7 is a screenshot of an exemplary graphical user interface for a user to conduct a search;

FIG. 8 is a screenshot of an exemplary graphical user interface providing a user an option to input natural language to conduct a search;

FIG. 9 is a screenshot of an exemplary graphical user interface illustrating a user input facilitated by recommendations provided by the graphical user interface to conduct a search; and

FIG. 10 is a screenshot of an exemplary graphical user interface illustrating an intelligent search performed by the technology as compared to a traditional filter panel.

### DETAILED DESCRIPTION

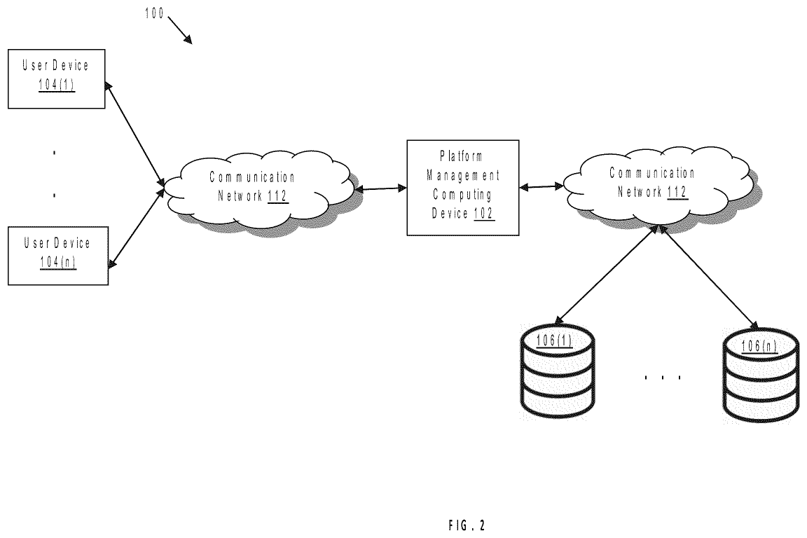

A network environment 100 with an exemplary platform management computing device 102 configured to intelligently generate a search query to access data via a customized graphical user interface is shown in FIG. 2. In this particular example, the environment 100 includes the platform management computing device 102, user devices 104(1)-104(n), and databases 106(1)-106(n) which are coupled together via communication networks 112, although the environment could have other types and/or numbers of other systems, devices, components, and/or other elements in other configurations. This technology provides several advantages including providing methods, non-transitory computer readable media, and computing devices that substantially enhance the intelligent generation of a search query to access data via a customized graphical user interface.

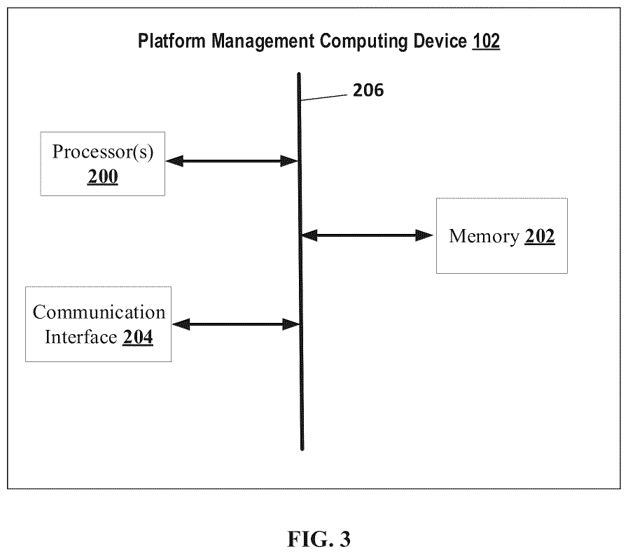

Referring more specifically to FIGS. 2 and 3, the platform management computing device 102 of the network environment 100 may perform a number of different functions and/or other operations as illustrated and described by way of the examples herein, including intelligently generate a search query to access data based on a user's input in natural language received via a user interface. The platform management computing device 102 in this example includes processor(s) 200, a memory 202, and a communication interface 204, which are coupled together by a bus 206, although the platform management computing device 102 can include other types or numbers of elements in other configurations.

The processor(s) 200 of the platform management computing device 102 may execute programmed instructions stored in the memory 202 of the platform management computing device 102 for any number of the functions and other operations as illustrated and described by way of the examples herein. The processor(s) 200 may include one or more central processing units (CPUs) or general-purpose processors with one or more processing cores, for example, although other types of processor(s) can also be used.

The memory 202 of the platform management computing device 102 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s) 200, can be used for the memory 202.

Accordingly, the memory 202 can store applications that can include computer executable instructions that, when executed by the platform management computing device 102, cause the platform management computing device 102 to perform actions, to intelligently generating a search query to access data as illustrated and described by way of the examples herein. The application(s) can be implemented as components of other applications, operating system extensions, and/or plugins, for example.

Further, the application(s) may be operative in a cloud-based computing environment with access provided via a software-as-a-service model. The application(s) can be executed within or as virtual machine(s) or virtual server(s) that may be managed in a cloud-based computing environment. Also, the application(s), and even the platform management computing device 102 itself, may be located in virtual server(s) running in a cloud-based computing environment rather than being tied to specific physical network computing devices. Also, the application(s) may be running in virtual machines (VMs) executing on the platform management computing device 102 and managed or supervised by a hypervisor.

The communication interface 204 of the platform management computing device 102 operatively couples and communicates between the platform management computing device 102 and one or more of the user devices 104(1)-104(n), and/or the databases 106(1)-106(n), via one or more communication networks 112, although other types or numbers of communication networks or systems with other types or numbers of connections or configurations to other devices or elements can also be used.

While the platform management computing device 102 is illustrated in this example as including a single memory 202 and communication interface 204, the platform management computing device 102 in other examples can include a plurality of memories 202 and communication interfaces 204 as appropriate and needed to implement one or more operations or functionalities of this technology.

Referring to FIG. 2, each of the user devices 104(1)-104(n) includes one or more processors, a memory, user input device(s), such as keyboards and/or mouse pointers by way of example, a display, such as an LED or LCD display device, and a communication interface, which are coupled together by a bus or other communication link, although other types and/or numbers and types of components or other elements in other configurations could be used. In this example, each of the user devices 104(1)-104(n) may interact with the platform management computing device 102 to perform a search of properties in real estate, although the user devices could be operated by other applications to implement other functionalities and operations (e.g., accessing and managing other information, such as other types of assets).

The databases 106(1)-106(n) may store real estate data associated with a variety of properties being accessed by a user in this example, although types and/or combinations of data and/or other programmed instructions may also be stored, and other storage locations may be used. In some examples, instead of storing information of the properties themselves (e.g., size, built year, market value, etc.), the databases 106(1)-106(n) may additionally store other information relating to the properties, such as nearby public transit, conveniency of leisure such as restaurants, shopping malls, or the like.

The communication networks 112 may be, for example, one or more of the same or different combinations of an ad hoc network, an extranet, an intranet, a wide area network (WAN), a virtual private network (VPN), a local area network (LAN), a wireless LAN (WLAN), a wireless WAN (WWAN), a metropolitan area network (MAN), internet, a portion of the internet, a portion of the public switched telephone network (PSTN), a cellular telephone network, a wireless network, a Wi-Fi network, a worldwide interoperability for microwave access (WiMAX) network, or a combination of two or more such networks, although other types and/or numbers of networks in other topologies or configurations may be used.

In the exemplary network environment illustrated in FIG. 2, the platform management computing device 102, the user devices 104(1)-104(n), and the databases 106(1)-106(n) are shown as dedicated hardware devices. However, one or more of the platform management computing devices 102, the user devices 104(1)-104(n), and the databases 106(1)-106(n) can be implemented in software within one or more other devices located at either the same physical place or distributed in the network environment 100.

Although the exemplary network environment 100 with the platform management computing device 102, the user devices 104(1)-104(n), and the databases 106(1)-106(n) are described and illustrated herein, other types or numbers of systems, devices, components, or elements in other topologies can be used in other exemplary network environments. It is to be understood that the systems of the examples described herein are merely for exemplary purposes, as many variations of the specific hardware and software used to implement the examples are possible, as will be appreciated by those skilled in the relevant art(s).

Moreover, one or more of the components depicted in the network environment 100, such as the platform management computing device 102, the user devices 104(1)-104(n), and the databases 106(1)-106(n), for example, may also be configured to operate as virtual instances on the same physical machine. In other words, one or more of the platform management computing devices 102, the user devices 104(1)-104(n), and the databases 106(1)-106(n) may operate on the same physical device rather than as separate devices communicating through one or more communication networks 112.

The examples of this technology may also be embodied as one or more non-transitory computer readable media having instructions stored thereon, such as in the memory 202 by way of example, for one or more aspects of the present technology, as described and illustrated by way of the examples herein. The instructions in some examples include executable code that, when executed by one or more processors, such as the processor(s) 200, cause the processors to carry out steps and operations necessary to implement the methods of the examples of this technology that are described and illustrated herein.

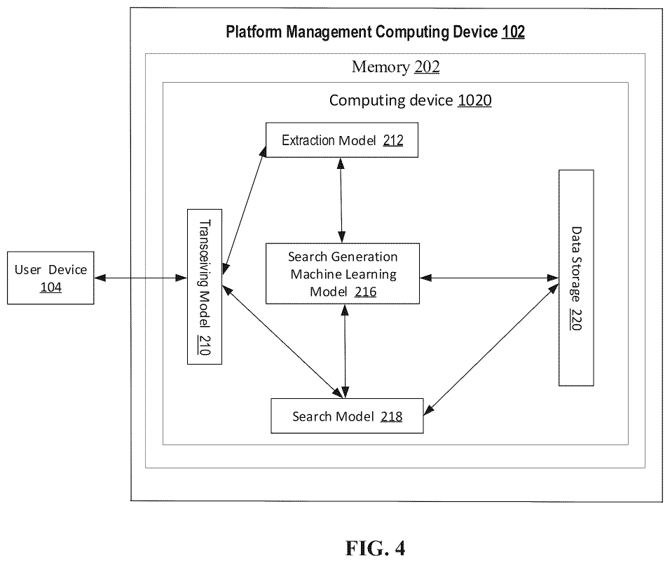

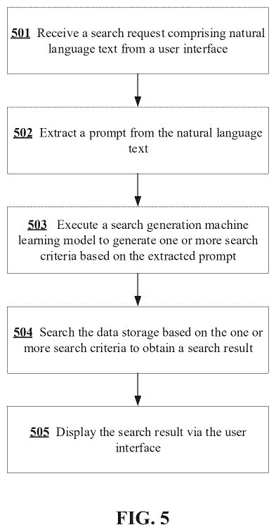

Referring to FIG. 4, a block diagram of an exemplary computing device 1020 is illustrated as residing on and being executed by the platform management computing device 102 for performing one or more steps and operations described herein for this disclosed technology. As shown in FIG. 4, the memory 202 includes the computing device 1020, which in turn comprises a transceiving model 210, an extraction model 212, a search generation machine learning model 216, a search model 218, and a data storage 220. It is to be understood that the memory 202 may comprise other types and/or numbers of other modules, engines, programmed instructions and/or data. In this example, the transceiving model 210 may be configured to communicatively connect with one or more user devices 104 and thereby allows a plurality of interactions (e.g., a search request initiated by a user device 104) between the user devices 104 and the computing device 1020. The extraction model 212 may be configured to extract one or more prompts from natural language input by a user via a user device 104, to searching certain properties stored in data storage 220. The search generation machine learning model 216 may be executed by the computing device 1020, to generate one or more search criteria based on the extracted one or more prompts. The search model 218 may be configured to search the data storage 220 with the one or more search criteria generated by the search generation machine learning model 216 and obtain a search result. The computing device 1020 may cause the transceiving model 210 to transmit the obtained search result to the user device 104, thereby displaying the search result via a user interface of the user device 104. The data storage 220 herein may store information of a variety of real estate properties for a user of a user device 104 to access to. Details of various operations of those models in the computing device 1020 will be described below in conjunction with FIG. 5. It is to be understood that those models may execute other types and/or numbers of other functions and/or operations for other types of applications in other examples. Also, It is to be understood that although four models are illustrated in FIG. 4, however, any of those models can be combined as needed (e.g., combining extraction model 212 with search generation machine learning model 216 into a single machine learning based model), or any model may be further split or divided into several sub-models.

While the platform management computing device 102 is illustrated in FIG. 4 as including a single computing device 1020, the platform management computing device 102 in other examples may include a plurality of computing devices each may having one or more processors (each processor with one or more processing cores) that implement one or more steps of this technology. In these examples, one or more of the computing devices may have a dedicated communication interface or memory. Alternatively, one or more of the computing devices can utilize the memory, communication interface, or other hardware or software components of one or more other computing devices included in the platform management computing device 102. Additionally, one or more of the computing devices that together comprise the platform management computing device 102 in other examples can be standalone devices or integrated with one or more other devices or apparatuses.

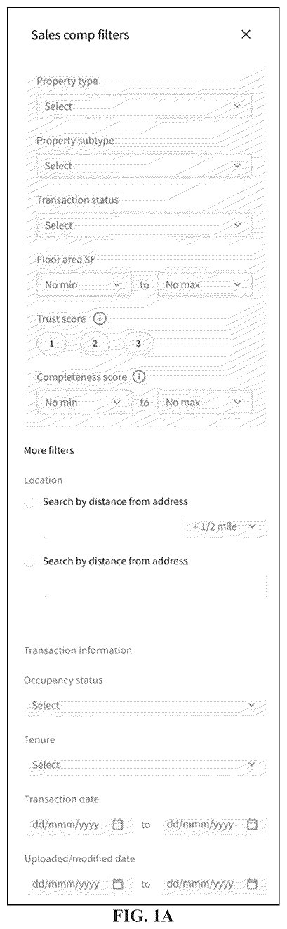

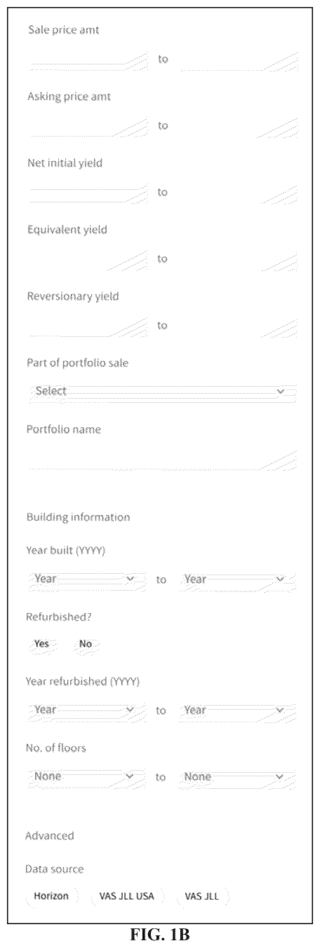

Referring to FIGS. 1-10, an exemplary method for intelligently generating a search query to access data is illustrated. More specifically, a flowchart of an exemplary method for intelligently generating a search query to access data is illustrated in FIG. 5.

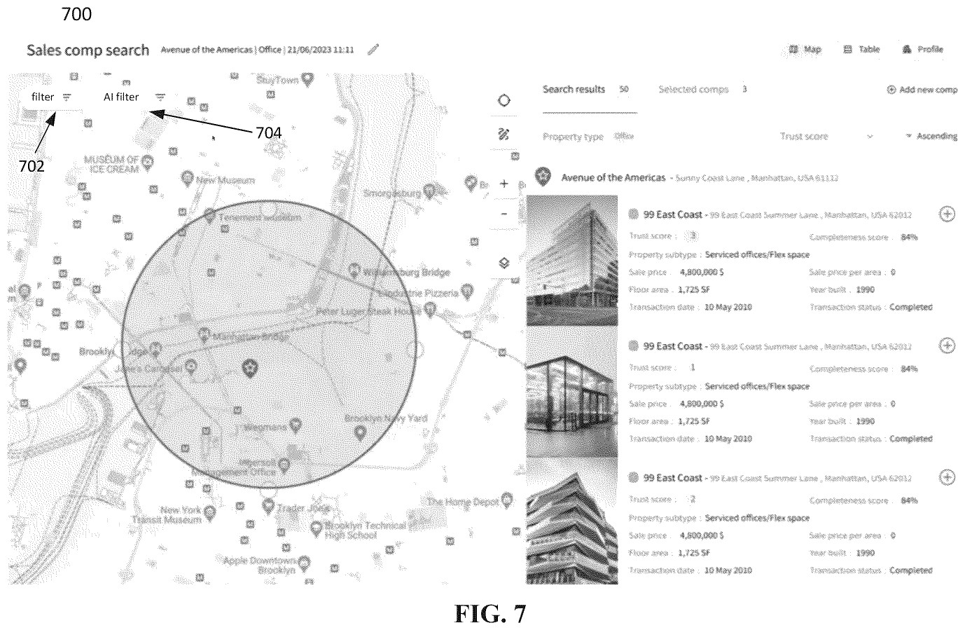

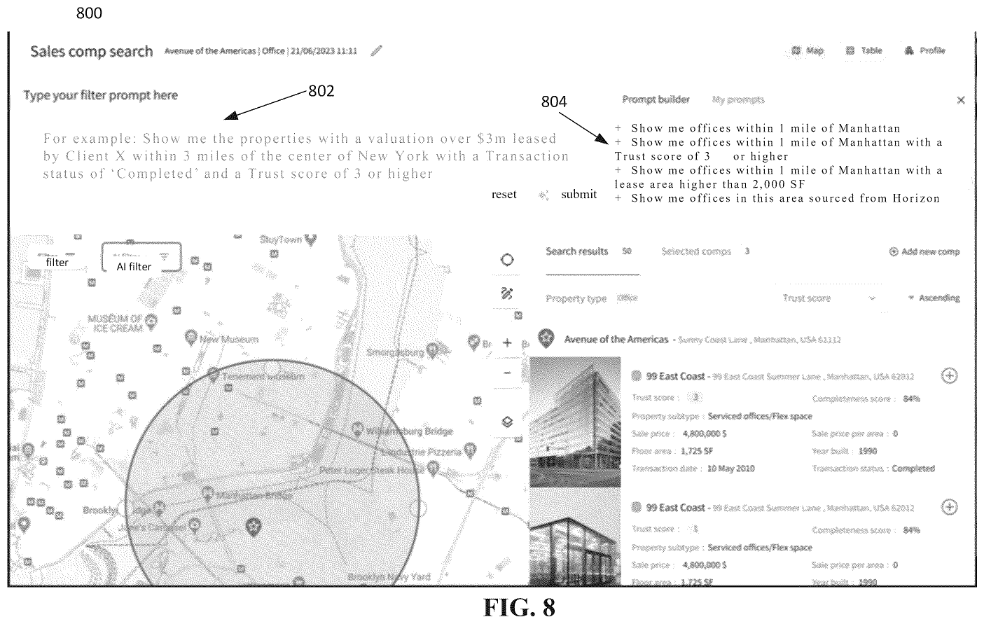

Referring to FIG. 5, at step 501, the transceiving model 210 of the computing device 1020 may receive a search request transmitted from a user device 104. The search request comprises natural language text input by a user via the user device 104. In this regard, the platform management computing device 102 may provide a graphical user interface 700 as illustrated in FIG. 7, and the computing device 1020 executed at back end may receive data a user input into the graphical user interface 700 via the transceiving model 210. A user may access to the graphical user interface 700 via a browser or an application installed on the user device 104. In this example, the graphical user interface 700 may provide a filter 702 and AI filter 704 for a user to conduct a search of properties from real estate data stored in the data storage 220. The filter 702 can be a traditional filter panel like the one illustrated in FIGS. 1A-1B, which has a plurality of interactive elements or fields for the user to input or select a search condition or requirement to filter out the properties that the user may be interested in from hundreds or thousands of properties stored in the data storage 220. For example, the user may choose property type, size, location, price, etc. The AI filter 704 may be a more intelligent user interface by use of Artificial Intelligence technology. AI filter 704 may enable the user to input natural language, as a search creation conduct to perform a search of his or her interested properties. The user may be guided to the AI filter 704 interface by tapping the “AI filter” button shown in FIG. 7. Then as illustrated in FIG. 8, the user is guided to a graphical user interface 800 comprising a text field 802 for the user to input natural language text to conduct a search. The text field 802 is an interactive component that works as a natural language input interface. As compared to a traditional filter panel as illustrated in FIGS. 1A-1B or as provided by the filter 702 in FIG. 7 which has fixed criteria or interactive fields for the user to choose, the text field 802 in FIG. 8 allows the user to freely input any criteria that he or she wants to include in the search. In this regard, the text field 802 may be considered as an intelligent and interactive element incorporated into the graphical user interface 800, which allows the user to customize his or her own search request.

In the example shown in FIG. 8, the computing device (e.g., computing device 1020 in FIG. 4) employs Artificial Intelligence technology to analyze, interpret, and transmit the natural language input by the user (e.g., on a machine learning basis). With “Type your filter prompt here” above the text field 802, the user is suggested typing text in text field 802. It is to be understood that such prompt, similar to the search condition, requirement, or filter as mentioned above, works or functions as an item or condition used during a search to filter out the target properties for the user among a large amount of data stored in the data storage 220. Therefore, as technology evolves, other technique may be utilized. It is also possible that instead of AI, other available or appropriate existing technology may be used to fulfill functions described herein (e.g., machine learning model(s) trained by one or more neural networks).

Additionally, or optionally, an example of “For example: Show me the properties with a valuation over $3 m leased by Client X within 3 miles of the center of New York with a Transaction status of ‘Completed’ and a Trust score of 3 or higher” may be given in the text field 802 itself, as illustrated in FIG. 8. Such example may be helpful for a user who is new or unfamiliar with this web page or mobile application. In this example, a user may input text into the text field 802. In some examples, the user may input his or her natural language search request in audio, which may be transmitted into text by a plug-in or other components incorporated in the graphical user interface 800.

In some examples, as shown in FIG. 8, the graphical user interface 800 may further provide a “Prompt Builder” field 804 to provide one or more recommended prompts to the user to supplement and support the user to compose his or her input. For example, “show me offices within 1 mile of Manhattan,” as illustrated in FIG. 8. A user who knows how to compose his or her own search request may type any prompt(s) that he or she may think of directly in the text field 802. In a case that a part of the desired search request is shown as one or more recommendations within the Prompt Builder field 804, the user may simply tap to choose the corresponding recommendation(s). Then the selected recommendation(s) can be populated into the text field 802 directly. This additional or optional function provided by the graphical user interface may further facilitate the user to perform a search. This function may also be helpful for users that do not know how to start a search. By selecting any of the recommendations to have some attempts, a user would be able to have a better understanding of this intelligent searching tool, i.e., the graphical user interface 800 and its relevant devices running at backend.

In some examples, the one or more recommendations may be generated by the computing device 1020 and transmitted to the graphical user interface 800 via its transceiving model 210. This may be implemented by comprising additional models on the computing device or arranging existing model (s) to fulfill this operation (e.g., the search model 218, or search generation machine learning model 216). In some examples, the recommendation(s) may be generated based on the profile of a user after the user's login of his or her account. In some other examples, the recommendation(s) may be generated based on a preference of that user, preference of this type of user (e.g., commonly or frequently selected prompt(s) that known to be important to the user, such as property investors, individual buyers, property sellers, etc.), historical prompt input by the user, prompts relate to or associated with historical prompt input by the user, a detected geographical location of the user, or any combination thereof.

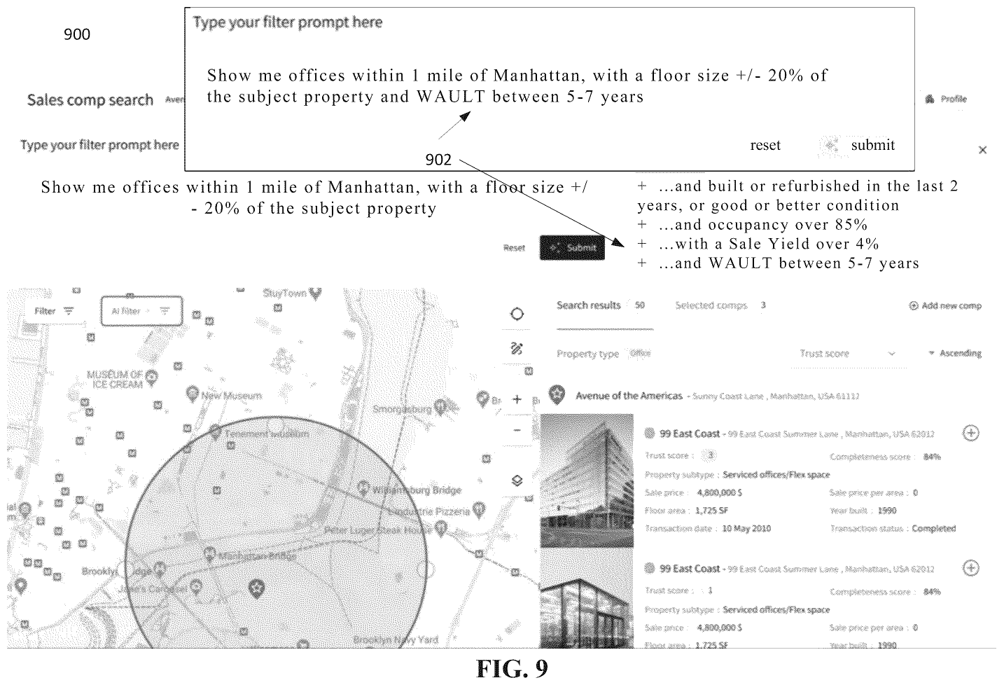

In some examples, the transmission of the one or more recommendations from the computing device 1020 to the graphical user interface 800 may be initiated or triggered by a user logging in his or her account. In some other examples, the computing device 1020 may further comprising a model configured to monitor or detect a user's input into the text field 802. Then in response to detecting an input by the user, the computing device 1020 may generate the one or more recommendations based on the user's input and transmit the generated recommendation(s) to the graphical user interface 800. In this way, a user may see a display of the one or more recommendations generated by the computing device 1020 in the Prompt Builder field 804 after inputting a natural language text into the text field 802. For example, when a user input “property” in the text field 802, a plurality of property types, or one or more locations that associated with a detected geography location or a registered location of the user may be displayed as the one or more recommendations. Similarly, in some examples, when the user changes his or her input in text field 802, the recommendation(s) generated and then displayed in the Prompt Builder field 804 may also change. Therefore, as a response to a user's input into the text field 802, the Prompt Builder field 804 may provide additional one or more recommended criteria. As an example, FIG. 9 illustrates a similar scenario. A user inputs “Show me office within 1 mile of Manhattan, with a floor size +/−20% of the subject property” into the text field 902. Then with a plurality of recommendations displayed in the Prompt Builder field, a user selected the recommended “and WAULT between 5-7 years” which is populated into the text field 902 as shown in FIG. 9. The user may submit a search request to perform a search after finishing the input. The user's submission may cause or trigger the search request to be transmitted to the transceiving model 210 of the computing device 1020.

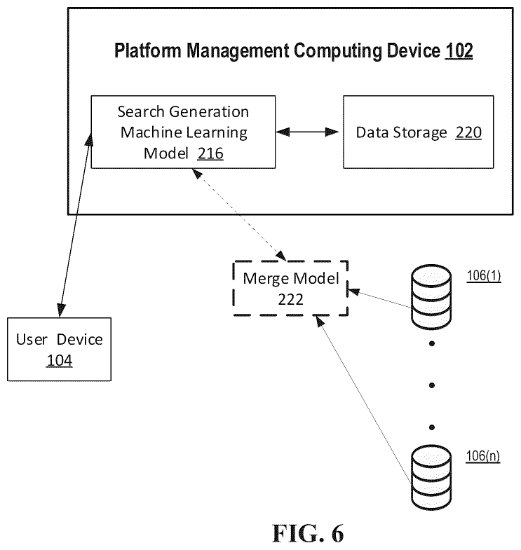

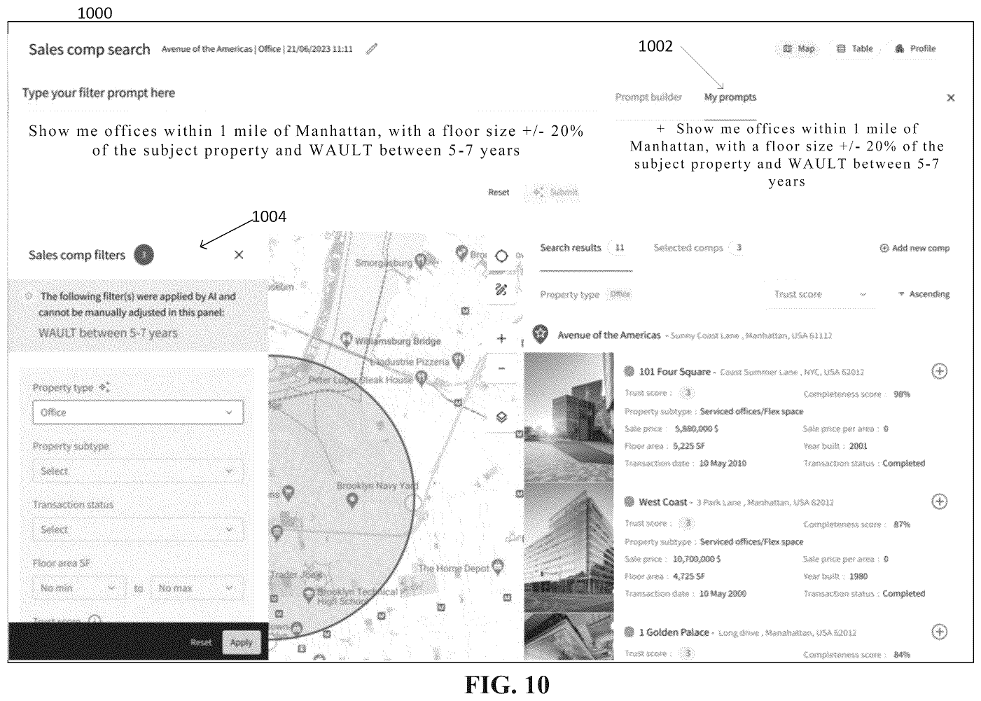

It is to be understood that with those exemplary screenshots of graphical user interface illustrated in FIGS. 6-9 and further in FIG. 10 which will be described below, an intelligent search tool enables a user to input a search request more freely, naturally and confidently is provided by this technology. In some cases, a user may submit a search request in a more automatic way by simply choosing appropriate recommendation(s) as discussed above. In some other cases, even the user starts his or her input by typing, the user may at least be facilitated to a certain extent. Those recommendations add another layer of intelligence of the technology.

Referring back to FIG. 5, at step 502, the extraction model 212 of the computing device 1020 may extract one or more prompts from the natural language text received via the transceiving model 210, which is input by the user via the user device 104. As discussed above, the extraction operation may be supported on a machine learning basis. In some examples, the extracted prompt(s) may comprise natural language audio in a case where the user's input is audio of natural language. It is to be understood that the computing device 1020 or the platform management computing device 102 may comprise additional model(s) or device(s) to process and transmit the audio data into text data. Herein, the prompt is extracted by removing no-relevant information (e.g., conjunction(s), pronoun(s), or the like) for the search included in the search request submitted by the user. For example, for a search request of “Show me office within 1 mile of Manhattan, with a floor size +/−20% of the subject property” submitted by the user, as illustrated in FIG. 9, “office,” “within 1 mile of Manhattan,” “floor size +/−20% of the subject property” may be the prompts extracted by the extraction model 212 from its received search request.

In some examples, the extraction model 212 may be trained with part or all the search request received by the transceiving model 210. Then the extraction model 212 may learn the pattern, characteristics of search requests composed by different users. In this way, the extraction model 212 may explore the underlying relationships among user's preferences or interests on the market, user's profile (e.g., user's type, such as an investor, an individual buyer, an individual seller, an enterprise, or the like). During such learning process, the extraction model 212 may find emerging prompts that users would like to use, which does not exist in the search generation machine learning model 216. Then extraction model 212 may send such prompts to the search generation machine learning model 216, which can be a basis for expanding one or more criteria (will be described below).

At step 503, the computing device 1020 may execute the search generation machine learning model 216 to generate one or more search criteria based on the prompts extracted by the extraction model 212. The search generation machine learning model 216 may be trained to learn data storage structure information of the data storage 220. The structure information for the search generation machine learning model 216 to learn may comprise relationship(s) between tables in the data storage 220, the fields and columns in the table (e.g., the title of each column, the content in each row, etc.). In this way, the search generation machine learning model 216 may learn the way or manner that the data storage 220 uses to sort its stored information. Accordingly, the search generation machine learning model 216 may explore all the filters that the data storage 220 use to sort the stored data. That is to say, with the data stored (e.g., stored as table(s)) in the data storage 220 as input of the search generation machine learning model 216, one or more criteria may be obtained as an output of the training. The training process may comprise analyzing, classifying and synthesizing, or other appropriate operations on the stored data. Then the criteria obtained and maintained by the search generation machine learning model 216 may embody the various filters used in the data storage. In some examples, the training may be executed iteratively, thereby the search generation machine learning model 216 may maintain updated criteria.

In some examples, the search generation machine learning model 216 may receive one or more prompts transmitted by the extraction model 214 as discussed above. Those prompts are included in a search request submitted by a user. However, they do not exist in the search generation machine learning model 216 yet. That is to say, the one or more criteria maintained by the search generation machine learning model 216 cannot meet the user's need. This may indicate the data storage itself lacks such filter, or the search generation machine learning model 216 lacks a criterion to match the field or column of the tables in the data storage 220. In the former case, the search generation machine learning model 216 may suggest (e.g., an administrator) to add an additional column of the tables stored in the data storage 220, based on an analysis or learning of the search requests (e.g., analyzed by the search generation machine learning model 216 or the extraction model 214). For example, a suggest may be made when the number of receiving a specific prompt exceeding a predetermined threshold. In the latter case, the search generation machine learning model 216 may add a corresponding criterion by learning of the extracted prompt. In some other examples, the search generation machine learning model 216 may suggest replacing or changing an existing column or filed of one or more tables stored in the data storage 220. Accordingly, the structure of data storage 220 may be optimized and therefore be updated along with the trends in the industry or on the market.

At step 503, the search generation machine learning model 216 of the computing device 1020 may map the extracted prompt(s) to one or more search criteria it maintained, based on the learned data storage structure information. It is to be understood that the prompt(s) extracted by the execution model 212 represent content in the original search request submitted by the user via the user device 104. While the one or more search criteria maintained by the search generation machine learning model 216 represent the data storage structure information as discussed above. Accordingly, the mapped one or more criteria may be the same as the extracted prompt(s), if the search request submitted by the user has a perfect match with the data storage structure information (e.g., filters it utilizes to sort the stored data, such as property type, size, price, market value, nearby traffic, conveniency, commercial resource, commercial vibrancy, office agglomeration, etc.) of data storage 220. But in most cases, the mapped one or more criteria may be different from the extracted prompt(s). Due to the learned data storage structure information of the data storage 220, the search generation machine learning model 216 allows for a more comprehensive and thorough search. This contributes a further layer of intelligence to this technology.

Referring to FIG. 6, an exemplary functional block diagram illustrating a training of the search generation machine learning model 216 is illustrated. In FIG. 6, the user device 104 may get benefit of the intelligence of the search generation machine learning model 216 as discussed above through interactions between the user device 104 and the platform management computing device 102. Moreover, FIG. 6 additionally shows other resources may be used to train the search generation machine learning model 216. Optionally or additionally, the search generation machine learning model 216 may be trained with other data resources, such as databases 106(1)-106(n) as illustrated in FIG. 2. The databases 106(1)-106(n) may be internal data resources of an enterprise or external third-party data resources that may be useful for the search generation machine learning model 216 to explore the data storage structure information. The databases 106(1)-106(n) may store additional data related to the properties stored in the data storage 220. In some other examples, the databases 106(1)-106(n) may be also function as an expansion of the data storage 220. In other words, the stored data that can be searched by the search model 218 comprise the data storage 220 and the databases 106(1)-106(n). In a case that the databases 106(1)-106(n) are used, the computing device 1020 or the platform management computing device 102 itself may further comprise a merge model 222 as shown in FIG. 6. The merge model 222 may ingest, process to cross correlate and merge the data storage 220, and the databases 106(1)-106(n) together. It is to be understood that even though a plurality of databases 106 are illustrated in FIG. 6, any appropriate number of databases 106 may be selected in a practical network environment, such as a single database 106, or more than one databases 106.

Referring back to FIG. 5, at step 504, the search model 218 of the computing device 1020 may search the data storage 220 with the one or more search criteria selected by the search generation machine learning model 216 and obtains a search result. At step 505, the transceiving model 210 of the computing device 1020 may transmit the search result obtained by the search model 218 to the exemplary graphical user interfaces as illustrated in FIGS. 7-9. This may cause the search result to be displayed via the user interface, as a response to the search request submitted by the user.

As illustrated in FIG. 10, a search result may be displayed on the lower right of the exemplary graphical user interface 1000. In this example, the content of the search request submitted by the user is shown in the My prompts field 1002. Then when the user wants to have the same search result, he or she does not need to re-input the search result as which is required in a traditional filter panel (e.g., the filter panel in FIGS. 1A-1B). Instead, the user may simply choose the corresponding search request that displayed in the My prompts field 1002. The one selected by the user may be populated into the text field on the left upper portion of the graphical user interface 1000 automatically. This feature allows the user to re-submit a search request in a productive way. This feature further adds another layer of the intelligence of the technology disclosed herein.

In some examples, the one or more criteria that the search generation machine learning model 216 maps or selects based on the prompt extracted by the extraction model 212 may be displayed on the user interface. The display may be triggered by a user submitting a search request. This means, after the user submit his or her search request, and as soon as the one or more criteria is selected by the search generation machine learning model 216, they one or more criteria may be used to updated and displayed on the user interface. This allows the user to have a reference and learn what criterion is or criteria are used for conducting the search. This feature may enable a better understanding of the user about how the search is performed, and thereby may have a better-quality search request next time. As an example, which is illustrated in FIG. 10, the one or more criteria that the search generation machine learning model 216 maps or selects may be populated into respective fields of a traditional filter panel 1004 on the lower left portion of graphical user interface 1000. After being updated, the filter panel 1004 may have a notification or an alert to the user (e.g., a bubble). Herein, an extra criterion “WAULT between 5-7 years” is shown on the top of the filter panel 1004 because it is not a field or filter provided by the filter panel. Therefore, this is also an example to show extra one or more criteria that the search generation machine learning model 216 may utilize for searching the data storage 220. Accordingly, this technology allows a personalized or customizable search of data stored in data storage 220.

Furthermore, as illustrated in FIG. 10, the traditional filter panel 1004 may provide some insights about the difference between such traditional filter panel and this technology and how powerful this technology (e.g., the AI filter) could be when performing a search of the data storage 220. Optionally, a user may close this traditional panel by clicking or taping the “x” button. This allows a further advantage with the AI filter, i.e., an extra space may be available to show either the map or the search result without having the traditional panel obscuring some content thereof.

In some examples, a user may want to modify or change the search request he or she submitted to refine the search result displayed on the graphical user interface 1000, after reviewing the search result or the one or more criteria displayed in the filter panel. If this is the case, the user may continue to input natural language into the user interface (e.g., the text field 802 in FIG. 8) to refine the search result. In this regard, the graphical user interface 1000 may be configured to provide a separate interactive component which is not shown in FIG. 10 (e.g., a “re-fine” or “re-submit” or similarly labeled button close to the “submit” button). Then by detecting such change or modification made by the user based on a display of those one or more criteria via the graphical user interface 1000, the computing device 1020 may cause the extraction model 212 to extract a prompt and execute the search generation machine learning model 216 to obtain one or more updated search criteria. This process is similar as discussed above. Then the search model 218 may conduct a search of data storage 220 with the one or more updated search criteria. A refined search result may in turn be displayed on the graphical user interface 1000. By way of example, the computing device 1020 or the platform management computing device may detect the change or modification by monitoring user's input into the graphical user interface 1000. Then a refined search result may be displayed right after the user's input. By way of another example, the change or modification may be detected by submitting a refine request by the user via the separate interactive component discussed above. In some further examples, the user may simply submit a new search request. Then a process described in conjunction with FIGS. 5-10 may be performed again.

In some examples, the computing device 1020 may be configured to generate prompt recommendation(s) based on one or more prompts extracted by the extraction model 212, and/or the one or more criteria determined by the search generation machine learning model 216. Then the generated prompt recommendation(s) may be transmitted via the transceiving model 210 and thereby displayed in the Prompt Builder field of the graphical user interface 1000. In some examples, such generated prompt recommendation(s) may be displayed in another dedicated field of the graphical user interface 1000. Because such prompt recommendation(s) are generated based on a previous search request submitted by the user, more insight may be provided to the user. Therefore, being displayed separately from the recommendation(s) in the Prompt Builder field, a user may pay more attention to this type of recommendation(s). Then in a case that the user wants to refine the search result or submit a new search request, the user's input may be further facilitated by the prompt recommendation(s) generated based on his or her previous search request.

It is to be understood that although the technology is described with a search of real property as an example, the technology is not limited to this and may be used for searching other stored data.

Accordingly, as described and illustrated by way of the examples herein, this technology provides methods, non-transitory computer readable media, and computing devices that intelligently generate a search query to access data. As illustrated by the examples herein, this technology allows a user's time consuming and manual work to be performed in a more natural and intelligent way which could take far less time. Moreover, in some examples, with a machine learning based model to learn the data structure information of a variety of data sources, more appropriate searching criteria may be maintained and used during the search, resulting in a better match with the inherent structure of the data source. In some examples, the machine learning based model may learn a plurality of logics may be taken into account for various search requests (e.g., possible values or criterion/criteria revealing insights for different property types). In some examples, the machine learning based model may be trained with exemplary invalid requests, prompts and criterion/criteria, and to avoid employ such criterion/criteria to conduct a search. Additionally, in some examples, the machine learning based model may optimize the data structure of data sources based on it learning and analyzing the received search requests submitted by the user. By learning from the true search request that reflect latest trends of one or more users, both the criteria and data structure of the system may be updated and accordingly improved to be in line with the change(s) in the industry or market. Furthermore, examples of this technology may be not limited to a specific language, and independent of a specific platform or product or application.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

1. A method comprising:
training, by a computing device, a search generation machine learning model, with data stored in a digital data storage as input training data, to output a plurality of criteria, the plurality of criteria indicating data storage structure used by the digital data storage to sort and store the data in the digital data storage;
receiving, by the computing device, a search request via a user interface, the search request comprising natural language text input by a user;
extracting, by the computing device, a prompt from the natural language text in the search request;
executing, by the computing device, the search generation machine learning model to generate one or more search criteria based on the extracted prompt and the plurality of criteria;
searching, by the computing device, the digital data storage based on the one or more search criteria to obtain a search result; and
displaying, by the computing device, the search result via the user interface as a response to the search request.

2. The method as set forth in claim 1, further comprising:
displaying, by the computing device, the one or more search criteria via the user interface.

3. The method as set forth in claim 2, further comprising:
detecting, by the computing device, a user modification on the basis of the displayed one or more search criteria via the user interface or the displayed search result;
obtaining one or more updated search criteria based on the user modification; and
the searching the data storage comprises:
searching the data storage based on the one or more updated search criteria to obtain the search result.

4. The method as set forth in claim 1, further comprising,
generating, by the computing device, one or more prompt recommendations based on the extracted prompt; and
displaying, by the computing device, the one or more prompt recommendations via the user interface.

5. The method as set forth in claim 1, further comprising,
detecting, by the computing device, a user input via the user interface;
generating, by the computing device, the one or more prompt recommendations based on the user input; and
displaying, by the computing device, the one or more prompt recommendations via the user interface.

6. The method as set forth in claim 1, further comprising,
generating, by the computing device, the one or more prompt recommendations based on at least one of a profile of a user submitted the search result, a preference of the user, a historical prompt input by the user, a geographical location of the user, or the one or more criteria; and
displaying, by the computing device, the one or more prompt recommendations via the user interface.

7. The method as set forth in claim 1, wherein the search request is submitted by a user via the user interface to perform a property search, and the prompt comprises at least one of text or audio input by the user.

8. A computing device, comprising a memory comprising programmed instructions stored thereon and one or more processors configured to execute the stored programmed instructions to:
train a search generation machine learning model, with data stored in a digital data storage as input training data, to output a plurality of criteria, the plurality of criteria indicating data storage structure used by the digital data storage to sort and store the data in the digital data storage;
receive a search request via a user interface, the search request comprising natural language text input by a user;
extract a prompt from the natural language text in the search request;
execute the search generation machine learning model to generate one or more search criteria based on the extracted prompt and the plurality of criteria;
search the digital data storage based on the one or more search criteria to obtain a search result; and
display the search result via the user interface as a response to the search request.

9. The computing device as set forth in claim 8, further comprising:
display the one or more search criteria via the user interface.

10. The computing device as set forth in claim 9, further comprising:
detect a user modification on the basis of the displayed one or more search criteria via the user interface or the displayed search result;
obtaining one or more updated search criteria based on the user modification; and
the searching the data storage comprises:
searching the data storage based on the one or more updated search criteria to obtain the search result.

11. The computing device as set forth in claim 8, further comprising,
generate one or more prompt recommendations based on the extracted prompt; and
display the one or more prompt recommendations via the user interface.

12. The computing device as set forth in claim 8, further comprising,
detect a user input via the user interface;
generate the one or more prompt recommendations based on the user input; and
display the one or more prompt recommendations via the user interface.

13. The computing device as set forth in claim 8, further comprising,
generate the one or more prompt recommendations based on at least one of a profile of a user submitted the search result, a preference of the user, a historical prompt input by the user, a geographical location of the user, or the one or more criteria; and
display the one or more prompt recommendations via the user interface.

14. The computing device as set forth in claim 8, wherein the search request is submitted by a user via the user interface to perform a property search, and the prompt comprises at least one of text or audio input by the user.

15. A non-transitory computer readable medium having stored thereon instructions comprising executable code which when executed by one or more processors, causes the one or more processors to:
train a search generation machine learning model, with data stored in a digital data storage as input training data, to output a plurality of criteria, the plurality of criteria indicating data storage structure used by the digital data storage to sort and store the data in the digital data storage;
receive a search request via a user interface, the search request comprising natural language text input by a user;
extract a prompt from the natural language text in the search request;
execute the search generation machine learning model to generate one or more search criteria based on the extracted prompt and the plurality of criteria;
search the digital data storage based on the one or more search criteria to obtain a search result; and
display the search result via the user interface as a response to the search request.

16. The non-transitory computer readable medium as set forth in claim 15, further comprising:
display the one or more search criteria via the user interface.

17. The non-transitory computer readable medium as set forth in claim 16, further comprising:
detect a user modification on the basis of the displayed one or more search criteria via the user interface or the displayed search result;
obtaining one or more updated search criteria based on the user modification; and
the searching the data storage comprises:
searching the data storage based on the one or more updated search criteria to obtain the search result.

18. The non-transitory computer readable medium as set forth in claim 15, further comprising,
generate one or more prompt recommendations based on the extracted prompt; and
display the one or more prompt recommendations via the user interface.

19. The non-transitory computer readable medium as set forth in claim 15, further comprising,
detect a user input via the user interface;
generate the one or more prompt recommendations based on the user input; and
display the one or more prompt recommendations via the user interface.

20. The non-transitory computer readable medium as set forth in claim 15, further comprising,
generate the one or more prompt recommendations based on at least one of a profile of a user submitted the search result, a preference of the user, a historical prompt input by the user, a geographical location of the user, or the one or more criteria; and
display the one or more prompt recommendations via the user interface.
